(19) United States
(12) Patent Application Publication
(10) Pub. No.: US 2023/0339732 A1
(43) Pub. Date: Oct. 26, 2023

(54) SYSTEMS AND METHODS FOR A DUAL MODE WINCH

(71) Applicant: Allied Motion Technologies Inc., Amherst, NY (US)

(72) Inventors: Ken MAY, Amherst, NY (US); Steven GEBHART, Amherst, NY (US); Kyle MACKAY, Amherst, NY (US)

(21) Appl. No.: 17/758,461

(22) PCT Filed: Jan. 7, 2021
(86) PCT No.: PCT/US2021/012556

§ 371 Date: Jul. 6, 2022

Related U.S. Application Data
(60) Provisional application No. 62/958,280, filed on Jan. 7, 2020.

(51) Int. Cl. B66D 1/46; B66D 1/12

(52) U.S. Cl. CPC B66D 1/46; B66D 1/12

(57) ABSTRACT

Systems and methods are provided for controlling a winch motor of an all-terrain vehicle (ATV). A system includes a processor and a communication interface configured to receive a winch status. A control circuit in electronic communication with the processor, where the control circuit is configured to operate a winch motor at a first voltage when the winch status is a first mode, and at a second voltage when the winch status is in a second mode. The second voltage is higher than the first voltage. A method includes receiving a winch status from a vehicle controller, where the winch status selectively indicates a first mode or a second mode. The method includes operating the winch motor at a first voltage when the winch status indicates the first mode, and at a second voltage when the winch status indicates the second mode. The second voltage is higher than the first voltage.

### CROSS-REFERENCE TO RELATED APPLICATIONS

This application claims priority to U.S. Provisional Application No. 62/958,280, filed on Jan. 7, 2020, now pending, the disclosure of which is incorporated herein by reference.

### FIELD OF THE DISCLOSURE

The present disclosure relates to controllers for winch motors, and more particularly to controllers for winch motors of off-road vehicles (for example, all-terrain vehicles (ATVs), utility vehicles (UTVs), etc.)

### BACKGROUND OF THE DISCLOSURE

Current winch products generally use brush motors. The introduction of Brushless DC (BLDC) motors and corresponding drives will improve power density and efficiency. Because BLDC motors may require microprocessors or similar intelligence, they also open the possibility to provide additional features and capabilities as compared to the comparatively simple controllers for brush motors. In this manner, such an intelligent winch system may also incorporate, for example, a Controller-Area Network (CAN) communication interface for communication with a vehicle controller.

FIG. 1 shows an example winch for an all-terrain vehicle (ATV). This assembly may include a winching mechanism, a BLDC motor, a gearbox, and on-board electronics. Because such winches operate at relatively low voltages (e.g., 12 volts), the corresponding currents are quite high, which makes sizing and thermal optimization very difficult.

### BRIEF SUMMARY OF THE DISCLOSURE

The present disclosure may be embodied as a system for controlling a winch motor of an off-road vehicle. The system includes a processor and a communication interface in electronic communication with the processor. The communication interface is configured to receive a winch status. The communication interface may be configured for communication with a vehicle system, for example, over a Controller-Area Network (CAN) bus. The system includes a control circuit in electronic communication with the processor. The control circuit is configured to operate a winch motor at a first voltage when the winch status is a first mode. The control circuit is further configured to operate the winch motor at a second voltage when the winch status is in a second mode. The second voltage is higher than the first voltage. In some embodiments, the system further includes a winch motor in operable communication with the control circuit. In some embodiments, the system further includes a winch having a winch motor in operable communication with the control circuit.

In another aspect, the present disclosure may be embodied as a method of controlling a winch motor of an off-road vehicle. The method includes receiving a winch status from a vehicle controller. For example, the winch status may be received from a CAN bus. The winch status selectively indicates a first mode (torque mode) or a second mode (speed mode). The method includes operating the winch motor at a first voltage when the winch status indicates the first mode, and operating the winch motor at a second voltage when the winch status indicates the second mode. The second voltage is higher than the first voltage.

### DESCRIPTION OF THE DRAWINGS

For a fuller understanding of the nature and objects of the disclosure, reference should be made to the following detailed description taken in conjunction with the accompanying drawings, in which:

FIG. 1 depicts an exemplary powered winch;

FIG. 2 shows a diagrams of a system according to the present embodiment and showing a winch motor and spool;

FIGS. 3A-3D are block diagrams depicting four winch control circuit architectures;

FIG. 4A is a graph showing exemplary winch motor design characteristics;

FIG. 4B is the graph of FIG. 4A with the addition of an exemplary (low-load, high-speed for plow blade raising and lowering, rope recovery mode, etc.) plow motor curve;

FIG. 4C is the graph of FIG. 4B showing effective performance of an embodiment of the present disclosure in boost mode;

FIG. 5 shows a winch control circuit with an active boost architecture according to an exemplary embodiment of the present disclosure; and

FIG. 6 shows a winch control circuit with a bidirectional boost architecture.

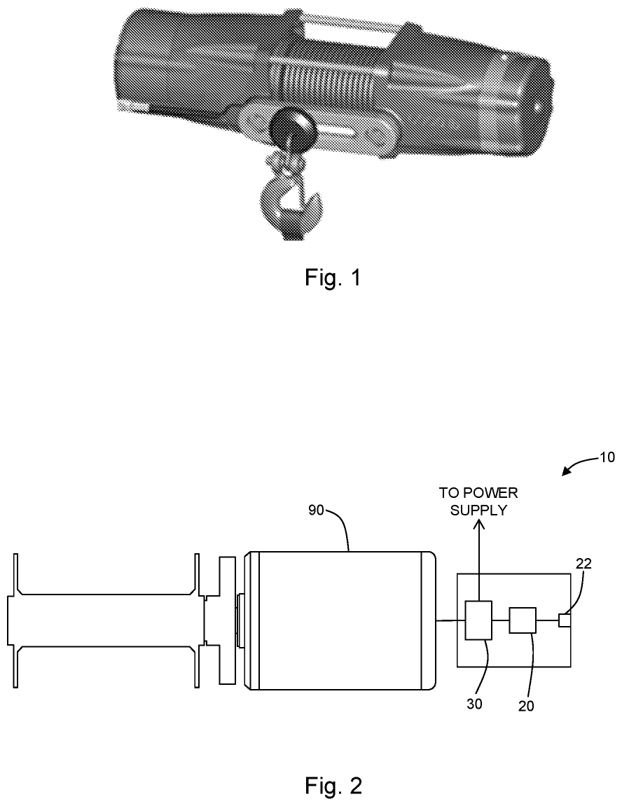

### DETAILED DESCRIPTION OF THE DISCLOSURE

The present disclosure takes advantage of a controller that may be present on a BLDC solution, and the observation that there are two distinctly different operating power points unique to this style of winch:
(1) First Mode (“Torque Mode”): In a first mode, the winch is used in the traditional way—e.g., freeing a stuck vehicle, etc. This mode requires high torque and medium speeds (i.e., lower speeds than the speed mode described below). Typically, for an ATV, this mode is around 1.5 kW or more of winch power (though one skilled in the art will recognize that embodiments of the present disclosure may provide more or less power in the torque mode).
(2) Second Mode (“Speed Mode”): In a second mode, the winch motor is used to quickly move a relatively small load. For example, a plow blade may be attached to the ATV, and the winch motor can then be used to quickly raise and lower the plow blade. In another example, the speed mode may be useful for rope recovery in a winch (i.e., re-spooling the rope with little or no load). Speed mode requires only low torque and relatively high speed (compared to torque mode). For an ATV, such operations may require approximately 100 watts of power (though one skilled in the art will recognize that embodiments of the present disclosure may provide more or less power in the speed mode).

With reference to FIG. 2, the present disclosure may be embodied as a system 10 for controlling a winch motor, for example, a BLDC motor. The system 10 includes a processor 20 and a communication interface 22 configured to communicate with other vehicle systems (e.g., a vehicle controller, etc.) For example, the communication interface may be configured to communicate using a CAN bus and/or any other communication scheme(s) including wired and wireless methods. The communication interface may be configured to receive a winch status indicating whether a first mode (torque mode) or a second mode (speed mode) is desired/active. The winch status may be provided in any way. For example, the winch status may be provided by the vehicle according to a selection made by an operator using a user interface of the vehicle (e.g., one or more switches, dials, buttons, interactive screens, wired or wireless remotes, fobs, etc.) In another example, the winch status signal may be provided according to a configuration of the vehicle. For example, attaching a plow blade to the ATV may cause the vehicle to automatically default to the speed mode, and removing the plow blade may cause the vehicle to revert to the torque mode.

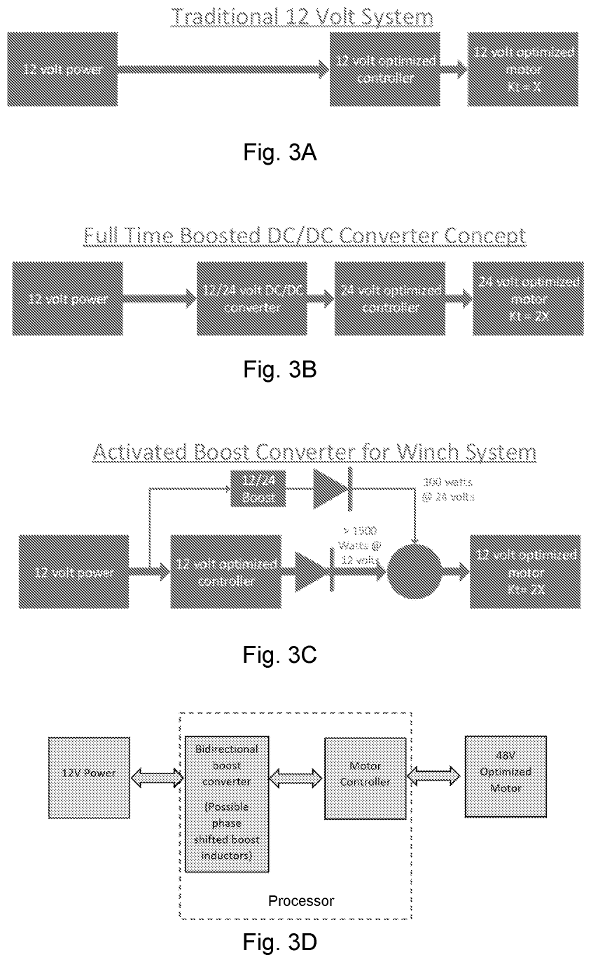

The system 10 includes a control circuit 30 in communication with the processor 20. The control circuit 30 is configured to operate a winch motor 90 at a first voltage when the winch status is a first mode (i.e., torque mode). For example, the first voltage may be 12 volts. As described above, the control circuit may provide, for example, 1500 watts or more at the first voltage (e.g., 12 volts). The operating power and/or first voltage may be higher or lower than the 1500 watts and 12 volts used in the examples of this disclosure. The control circuit is also configured to operate the winch motor at a second voltage when the winch status is a second mode (i.e., speed mode). For example, the second voltage may be 24 volts. The control circuit may provide, for example, 100 watts at the second voltage (e.g., 24 volts) when in the second mode. Here again, the operating power may be higher or lower than the 1500 watts used in the examples of this disclosure. The second voltage is higher than the first voltage. The control circuit may have any suitable architecture. FIGS. 3A-3D show architecture options, each one capable of controlling a winch.

FIG. 3A shows a traditional 12-volt system configuration. This is considered herein as the baseline approach to designing a winch system for a 12-volt powered system. The entire system is sized around the power supply (e.g., fixed at 12 volts) and the motor is sized for 12 volts as well. To accommodate the two very different modes of operation (torque mode and speed mode), compromises are made when considering motor size and/or characteristics.

FIG. 3B shows a full-time boost DC/DC converter architecture. This approach would boost the nominal input voltage (e.g., 12 volts) to something higher (e.g., 24 volts) all the time. In this architecture, the motor is optimized around a higher, but still fixed, power bus. In this manner, the motor itself is essentially the same size as in the traditional system of FIG. 3A, but the operating currents are lower—using the example boost voltage of 24 volts, the currents at the motor are half that of a traditional 12-volt system. This provides advantages for designing the control electronics and connector/cabling (e.g., lower cost, less weight, etc.) This may be thought of as a full-time boost circuit in that it operates at a boosted voltage all the time and sized for the maximum power draw under torque mode.

FIG. 3C shows an active-boost converter architecture of the present disclosure—an on-demand boost circuit. Such an on-demand boost circuit provides for the use of less power (e.g., ˜100 W) in speed mode and higher power (e.g., >1.5 kW) in torque mode. The diagram depicts a non-limiting example having a normal voltage of 12 volts, and a boosted voltage of 24 volts. Such an on-demand boost circuit may be smaller (utilizing lower current and power) than the full-time boost circuit described above with respect to FIG. 3B. Using such an on-demand boost circuit, the higher (boost) voltage can be activated only when in speed mode as indicated at the communication interface (e.g., over the CAN network, by a vehicle controller, etc.)

FIG. 5 is a high-level schematic of an example circuit used to achieve the presently-disclosed active boost function. Active boost can be achieved with very few components. The depicted example circuit includes only four discrete electronic components: a voltage control switch, a boost control switch, a diode, and an inductor (the capacitor shown in the figure would be present with or without the active boost circuit). The ‘voltage control circuit’ has several options one of which include being driven directly from a microprocessor of the controller. The voltage and boost circuits can be controlled based on an indication from a vehicle controller, communication bus, etc. as to which mode it is in (torque or speed). The voltage control circuit may be used to switch between boosted and non-boosted mode. The boost control may be modulated as part of the boost amplifier. The two power sources can be diode OR′d together such that whichever is of higher voltage is passed to an output-stage bridge circuit.

Table 1 shows the advantages and disadvantages of the architectures depicted in FIGS. 3A through 3C, where ‘B’ indicates the baseline, ‘S’ indicates the same or similar to baseline, ‘−’ indicates performance worse than baseline, and ‘+’ indicates better than baseline. It can be seen that the presently-disclosed active-boost solution is advantageous over the others.

TABLE 1

| | | | | | | | Con- |
|---|---|---|---|---|---|---|---|
| | Per- | | Thermal | | Recur- | | troller |
| | for- | Size/ | Manage- | Relia- | ring | | Technical |
| | mance | Weight | ment | bility | Cost | NRE | Risk |
| Traditional | B | B | w | B | B | B | B |
| 12 | | | | | | | |
| Volt | | | | | | | |
| System | | | | | | | |
| Full-Time | S | − | S | − | − | − | − |
| Boosted | | | | | | | |
| DC/DC | | | | | | | |
| Converter | | | | | | | |
| Activated | S | S | + | S | S | S | S |
| Boost | | | | | | | |
| Converter | | | | | | | |
| for Winch | | | | | | | |
| System | | | | | | | |

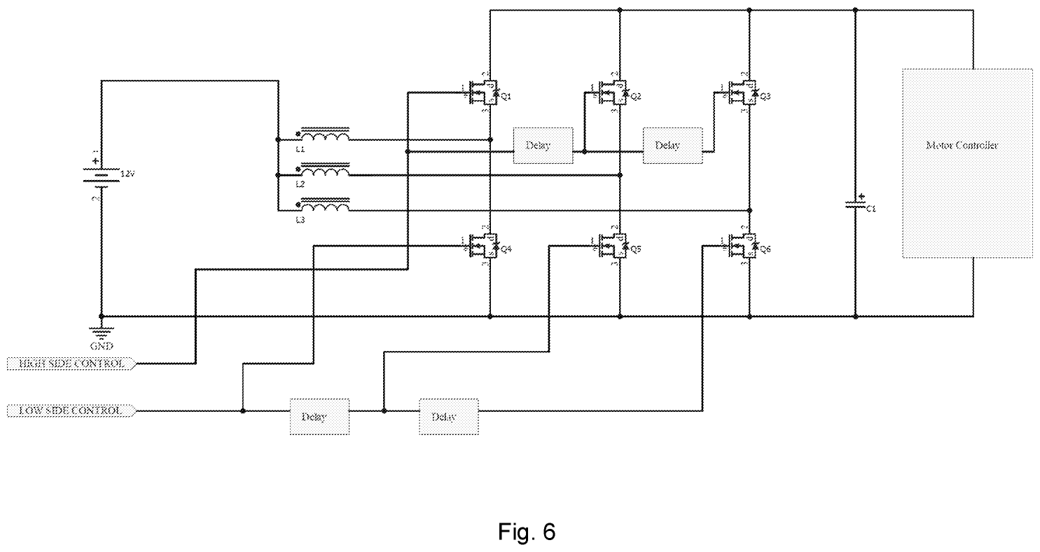

FIG. 3D depicts a bidirectional boost converter architecture according to another embodiment of the present disclosure. FIG. 6 shows a high-level schematic of such an architecture showing the use of distributed boost inductors (a boost inductor on each phase of the motor drive). A high-side control may be used to control MOSFETs on a high-voltage side of each phase of the motor drive (e.g., between each inductor and a high-voltage side of a motor controller), and a low-side control may be used to control corresponding MOSFETs on a low-voltage side of each phase of the motor drive (e.g., between each inductor and ground). The distributed boost inductors may all be driven with the same duty cycle. In some embodiments, each phase may be shifted as shown in the figure to reduce current ripple and provide better EMI performance. The processor may operate the high-side control and the low-side control according to the selected winch mode. The control circuit may include a set of two or more boost inductors, wherein each boost inductor of the set of two or more boost inductors is configured on a corresponding phase of the control circuit. For example, FIG. 6 shows a control circuit with three phases and a three boost inductors (L1, L2, and L3) corresponding to each of the phases. In some embodiments, at least one phase of the control circuit further comprises a delay circuit configured to provide a phase shift to reduce a ripple current and/or electromagnetic interference. The exemplary control circuit of FIG. 6 depicts that two of the three phases include delay circuits—each having a delay on the high side and a delay on the low side.

It should be noted that the terms “winch mode,” “torque mode,” “plow mode,” and “speed mode” are used for convenience and are not intended to be limiting as to the application. For example, “plow mode” may be used for applications other than plowing. As initially described above, torque mode is intended to convey a high torque, low-to-medium speed operating mode, and speed mode is intended to convey a low-torque, high-speed operating mode (i.e., relative to torque mode). Additionally, any specific values for voltage, power, current, torque, speed, etc. provided herein are intended to be non-limiting examples solely to illustrate embodiments of the present disclosure. For example, nominal input voltage may be other than 12 volts, and boost voltages are not necessarily two-times the nominal input voltage.

The processor 20 may be in communication with and/or include a memory. The memory can be, for example, a random-access memory (RAM) (e.g., a dynamic RAM, a static RAM), a flash memory, a removable memory, and/or so forth. In some instances, instructions associated with performing the operations described herein (e.g., operating a control circuit) can be stored within the memory and/or a storage medium (which, in some embodiments, includes a database in which the instructions are stored) and the instructions are executed at the processor.

In some instances, the processor includes one or more modules and/or components. Each module/component executed by the processor can be any combination of hardware-based module/component (e.g., a field-programmable gate array (FPGA), an application specific integrated circuit (ASIC), a digital signal processor (DSP)), software-based module (e.g., a module of computer code stored in the memory and/or in the database, and/or executed at the processor), and/or a combination of hardware- and software-based modules. Each module/component executed by the processor is capable of performing one or more specific functions/operations as described herein. In some instances, the modules/components included and executed in the processor can be, for example, a process, application, virtual machine, and/or some other hardware or software module/component. The processor can be any suitable processor configured to run and/or execute those modules/components. The processor can be any suitable processing device configured to run and/or execute a set of instructions or code. For example, the processor can be a general purpose processor, a central processing unit (CPU), an accelerated processing unit (APU), a field-programmable gate array (FPGA), an application specific integrated circuit (ASIC), a digital signal processor (DSP), and/or the like.

In another embodiment, the present disclosure may be embodied as a method of controlling a winch motor of an ATV. The method includes receiving a winch status from a vehicle controller. For example, the winch status may be received from a CAN bus. The winch status selectively indicates a first mode (torque mode) or a second mode (speed mode). The winch motor is operated at a first voltage (for example, 12 volts) when the winch status indicates torque mode. And the winch motor is operated at a second voltage (for example, 24 volts), higher than the first voltage, when the winch status indicates speed mode.

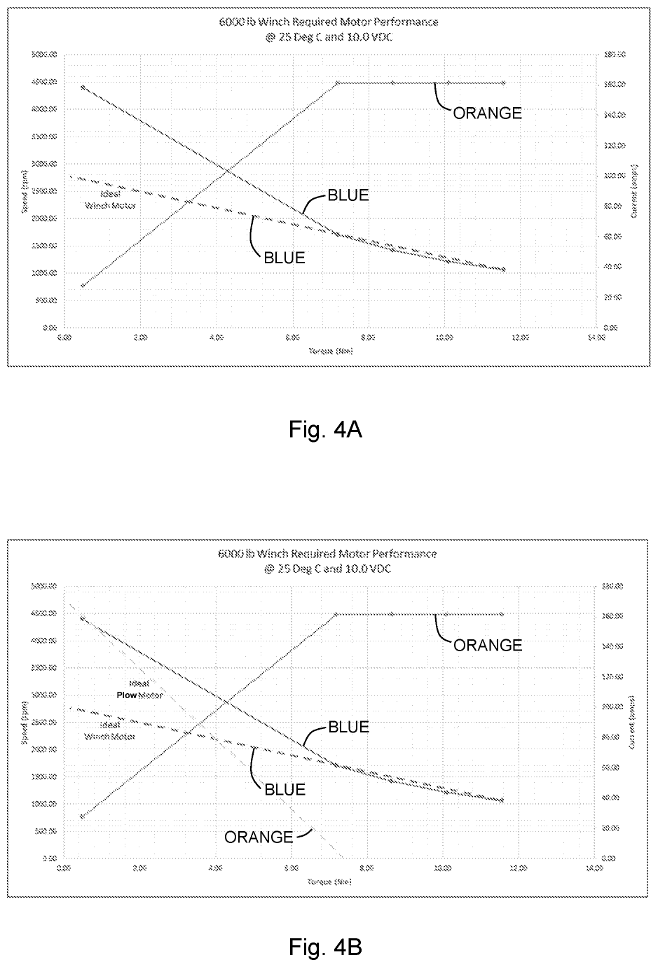

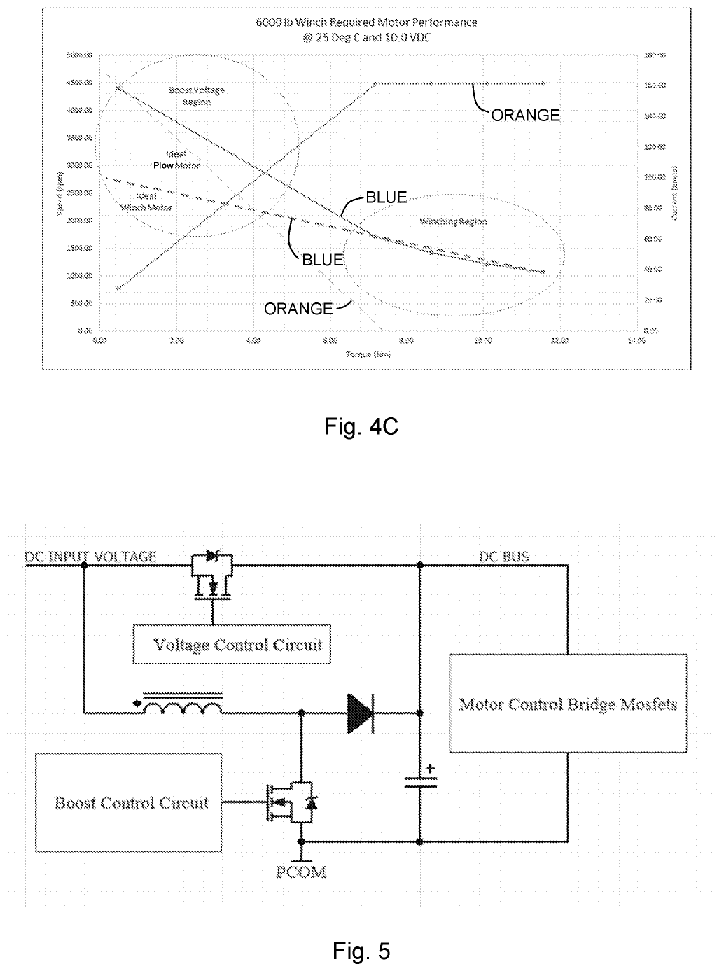

FIGS. 4A through 4C describe a typical motor sizing process in more detail. FIG. 4A shows a torque/speed curve for a motor designed for operation in torque mode (“winch motor” indicated by dashed blue line). FIG. 4B adds a torque/speed curve for a motor uniquely designed for operation in speed mode (“plow motor” indicated by dashed orange line). FIG. 4C shows an overlap of both of the above ideal motor torque/speed curves. The circled regions of “Winching Region” and “Boost Voltage Region” show that neither of the two ideal motor curves meet the needs of both modes. Embodiments of the present disclosure show the use of a boosted voltage in the plow (speed) mode that creates an effective torque/speed curve shown by the solid blue piecewise curve. The current/torque curve of the winch (torque) optimized motor is shown as solid orange.

Without a boost mode, a compromise motor designed for torque mode would have had about twice the motor phase currents. Motor current is the major thermal dissipation driver for the output switches and drives the sizes of connectors, etc. As thermal management will be one of the hardest design aspects, embodiments of the present disclosure greatly simplify this task.

Some exemplary characteristics embodiments presently-disclosed systems and methods may include:
(1) two very diverse power operating regions;
(2) use of a boost circuit allows optimizing the motor design for the torque mode while meeting the needs of speed mode;
(3) a boost circuit which can be employed with very few components;
(4) lower currents in the system with corresponding thermal management advantages;
and/or
(5) avoidance of the need for mechanical gearing to accommodate different torques and speeds.

Although the present disclosure has been described with respect to one or more particular embodiments, it will be understood that other embodiments of the present disclosure may be made without departing from the spirit and scope of the present disclosure.

We claim:

1. A system for controlling a winch motor of an off-road vehicle, comprising:
a processor;
a communication interface in electronic communication with the processor and configured to receive a winch status;
a control circuit in electronic communication with the processor, the control circuit configured to operate a winch motor at a first voltage when the winch status is a first mode, and wherein the control circuit having a boost circuit configured to operate the winch motor at a second voltage when the winch status is in a second mode, and wherein the second voltage is higher than the first voltage.

2. The system of claim 1, further comprising a winch having a winch motor in operable communication with the control circuit.

3. The system of claim 1, wherein the communication interface is configured for communication over a Controller-Area Network (CAN) bus.

4. The system of claim 1, wherein the control circuit comprises a set of two or more boost inductors, wherein each boost inductor of the set of two or more boost inductors is configured on a corresponding phase of the control circuit.

5. The system of claim 4, wherein at least one phase of the control circuit further comprises a delay circuit configured to provide a phase shift to reduce a ripple current.

6. The system of claim 1, wherein the first voltage is 12 volts.

7. The system of claim 1, wherein the second voltage is 24 volts.

8. A method of controlling a winch motor of an off-road vehicle, comprising:
receiving a winch status from a vehicle controller, the winch status selectively indicating a first mode or a second mode;
operating the winch motor at a first voltage when the winch status indicates the first mode; and
operating the winch motor at a second voltage when the winch status indicates second mode, wherein the second voltage is higher than the first voltage.

9. The method of claim 8, wherein the winch status is received from a CAN bus.

10. The method of claim 8, wherein the first voltage is 12 volts.

11. The method of claim 8, wherein the second voltage is 24 volts.
